(19) United States
(12) Patent Application Publication
(10) Pub. No.: US 2024/0006174 A1
(43) Pub. Date: Jan. 4, 2024

(54) Method for Controlling Mass Spectrometer

(71) Applicant: Hitachi High-Tech Corporation, Minato-ku, Tokyo (JP)

(72) Inventors: Riku TAMURA, Tokyo (JP); Hiroyuki YASUDA, Tokyo (JP); Yuka SUGAWARA, Tokyo (JP); Yuichiro HASHIMOTO, Tokyo (JP)

(21) Appl. No.: 18/037,292

(22) PCT Filed: Dec. 17, 2021
(86) PCT No.: PCT/JP2021/046871

§ 371 Date: May 16, 2023

(30) Foreign Application Priority Data
Dec. 17, 2020 (JP) 2020-209368

(51) Int. Cl. H01J 49/42

(52) U.S. Cl. CPC H01J 49/4215

(57) ABSTRACT

A method for controlling a mass spectrometer capable of identifying an abnormal location in a device is provided. A method for controlling a mass spectrometer including an ion source that ionizes a compound in a sample, a mass spectrometry unit that separates ions based on a mass-to-charge ratio, and a plurality of electrodes that form an electric field that transports ions generated by the ion source to the mass spectrometry unit includes ionizing the sample by the ion source, detecting, based on a change in ion permeability over time, ions accumulated in the electrodes and quadrupole mass filters forming the mass spectrometry unit, and detecting a change in ionization efficiency of the ion source based on a change in an amount of ions with respect to a gas flow rate for the ion source or a voltage of the ion source.

### TECHNICAL FIELD

The present invention relates to a method for controlling a mass spectrometer.

### BACKGROUND ART

The mass spectrometer includes: an ion source that ionizes a compound in a sample; a mass separator such as a quadrupole mass filter that separates ions derived from the compound based on a mass-to-charge ratio (m/z); and a detector that detects the separated ions.

PTL 1 describes an exhaust gas measurement device that includes amass spectrometry unit and can perform self-diagnosis of the device itself. PTL 1 describes that, “at the time of continuous measurement of measurement gas (exhaust gas) using a mass spectrometer, as a calibration means for a concentration of a measurement object in the exhaust gas and an output of a device, a substance having similar ionization efficiency to that of the measurement object, that is, a first standard substance which is a rare isotope and has a known constant concentration is added to a drawing line of the exhaust gas to measure an amount thereof, and at the time of calibration of the device, a second standard substance which is completely the same substance as the measurement object in the exhaust gas and has a known constant concentration is added to the drawing line of the exhaust gas to calibrate an amount thereof. Further, deterioration diagnosis of the device itself is performed by continuously monitoring temporal variation and the ionization efficiency of the first standard substance and the second standard substance, and efficiency of the mass spectrometry unit”.

### CITATION LIST

### Patent Literature

PTL 1: JP2002-189020A

### SUMMARY OF INVENTION

### Technical Problem

In PTL 1, no study is made on a specific means for determining which part of the device has an abnormality.

An object of the invention is to provide a method for controlling a mass spectrometer capable of identifying an abnormal location in a device.

### Solution to Problem

In order to solve the above object, for example, a configuration described in claims is adopted. The present application includes a plurality of means for solving the above object, and an example thereof is a method for controlling a mass spectrometer including an ion source that ionizes a compound in a sample, a mass spectrometry unit that separates ions based on a mass-to-charge ratio, and a plurality of electrodes that form an electric field that transports ions generated by the ion source to the mass spectrometry unit, the method including: ionizing the sample by the ion source, detecting, based on a change in ion permeability over time, ions accumulated in the electrodes and quadrupole mass filters forming the mass spectrometry unit, and detecting a change in ionization efficiency of the ion source based on a change in an amount of ions with respect to a gas flow rate for the ion source or a voltage of the ion source.

### Advantageous Effects of Invention

According to the invention, it is possible to provide the method for controlling a mass spectrometer capable of identifying an abnormal location in a device. Objects, configurations and effects other than those described above will be clarified by the following description of embodiments.

### BRIEF DESCRIPTION OF DRAWINGS

FIG. 1 is a diagram illustrating an overall configuration of a mass spectrometer according to Embodiment 1.

FIG. 2 is a measurement diagram illustrating a change in ionization efficiency.

FIG. 3 is a measurement diagram illustrating a change in ion permeability over time.

FIG. 4 is a diagram illustrating a procedure in a device self-diagnosis mode according to Embodiment 1.

FIG. 5 is a diagram illustrating a procedure for electrode polarity evaluation according to Embodiment 1.

FIG. 6 is a diagram illustrating a procedure for ion source characteristic evaluation according to Embodiment 1.

### DESCRIPTION OF EMBODIMENTS

Hereinafter, an embodiment will be described below with reference to the drawings.

### Embodiment 1

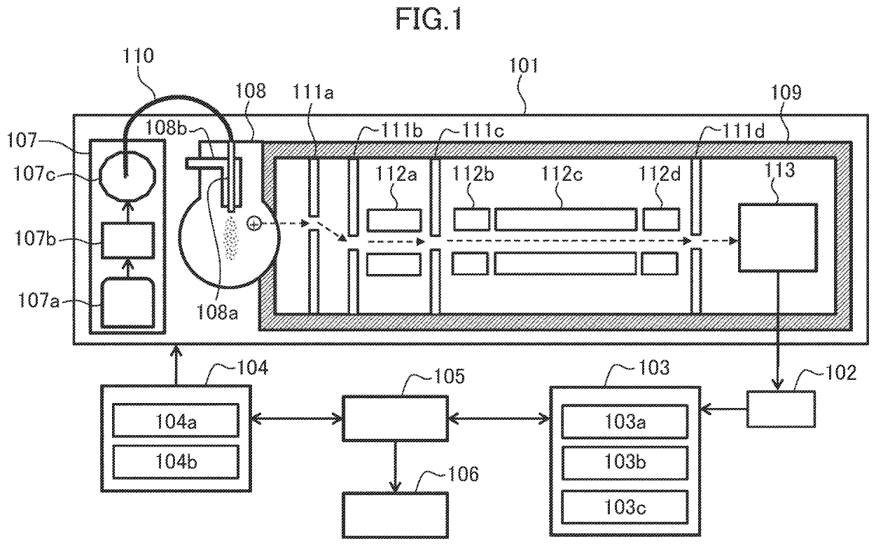

FIG. 1 is a configuration diagram illustrating main parts of a mass spectrometer according to Embodiment 1 of the invention. As shown in FIG. 1, the mass spectrometer of the present embodiment includes a measurer 101, an analog-to-digital converter (ADC) 102, a data analysis unit 103, an analysis controller 104, a main controller 105, and a display unit 106.

The measurer 101 includes a sample introducer 107, an ion introducer 108, and a vacuum chamber 109. The sample introducer 107 includes calibration sample solution 107a, a liquid delivery pump 107b, and an introduced sample switch valve 107c, and is connected to the ion introducer 108 via a pipe 110. The ion introducer 108 includes a sample introduction pipe 108a and a gas introduction pipe 108b. The vacuum chamber 109 includes electrodes 111a to 111d, quadrupole mass filters 112a to 112d, and an ion detector 113. The ion introducer 108 constitutes an ion source that ionizes a compound in a sample. The quadrupole mass filters 112a to 112d constitute a mass spectrometry unit that separates ions based on a mass-to-charge ratio. The plurality of electrodes 111a to 111d form an electric field that transports ions generated by the ion introducer 108 to the mass spectrometry unit.

The data analysis unit 103 includes a data storage unit 103a, a data analyzer 103b, and an error determiner 103c. The analysis controller 104 includes an electrode polarity evaluation controller 104a and an ion source characteristic evaluation controller 104b.

In the present embodiment, the main controller 105 is described in a form of mediation between the analysis controller 104 (the electrode polarity evaluation controller 104a and the ion source characteristic evaluation controller 104b) and the data analysis unit 103 (the data storage unit 103a, the data analyzer 103b, and the error determiner 103c), but the main controller 105 is only an example of a function block, and these controllers may be one controller. In addition, these controllers may be assembled in the mass spectrometer or may be provided outside the mass spectrometer.

Next, a measurement operation of the measurer 101 of the mass spectrometer of the present embodiment will be described.

Solution is introduced into the sample introduction pipe 108a through the introduced sample switch valve 107c and the pipe 110. A high voltage is applied to the sample introduction pipe 108a, and ions having the same polarity as a polarity of the applied high voltage are ejected from an introduction pipe as mist droplets. The ejected droplets are evaporated and condensed by high-temperature gas ejected from the gas introduction pipe 108b and introduced into the vacuum chamber 109 as monomolecular ions.

The ions introduced into the vacuum chamber 109 move in accordance with the electric field formed by the electrodes 111a to 111b or a gas flow formed by differential evacuation. A high DC voltage and a high AC voltage of several kilovolts from a high voltage generator (not shown) are applied to the quadrupole mass filters 112a to 112d, only ions having a specific mass-to-charge ratio corresponding to the applied voltages can pass through the quadrupole mass filters 112a to 112d in a long axis direction, and ions other than ions having the specific mass-to-charge ratio are diffused in directions other than the long axis direction.

In addition, a DC voltage of several to several tens of volts from a low voltage generator (not shown) is applied to the electrodes 111c to 111d and the quadrupole mass filters 112a to 112d so as to be able to adjust an inrush speed to the electrodes and adjust ion permeability. The ions having the specific mass-to-charge ratio which passed through the electrodes 111c to 111d and the quadrupole mass filters 112a to 112d reach the ion detector 113. A detection signal corresponding to an amount of the ions reaching the ion detector 113 is output.

The amount of the ions reaching the ion detector 113, that is, a detection sensitivity is described by the following Equation (1).

(Detection sensitivity)=(Amount of reaching ions)=(Ionization efficiency of ion introducer 108)×(Ion permeability in vacuum chamber 109) (1)

A spatial distribution of droplets of ions to be formed changes depending on accumulation of dirt on the tip of the sample introduction pipe 108a and a mounting state of the sample introduction pipe 108a. Accordingly, an optimum value of a voltage applied to the sample introduction pipe 108a and an optimum value of a gas flow rate introduced into the gas introduction pipe 108b change. That is, the ionization efficiency of the ion introducer 108 may change depending on a use situation, maintenance work, and the like.

### Experiment 1

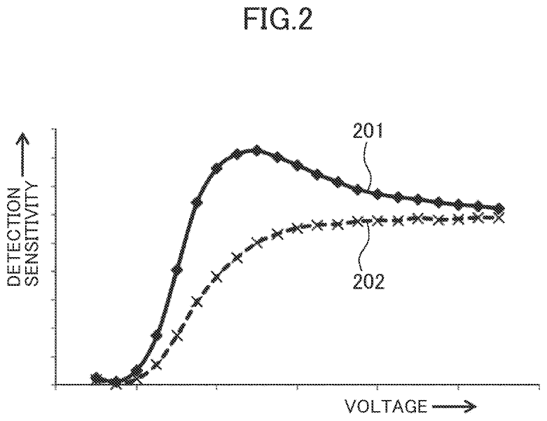

FIG. 2 illustrates a relation between a detection sensitivity and a voltage applied to a sample introduction pipe, which is obtained before and after the completely same sample introduction pipe is remounted. A curve 201 represents a relation before remounting, and a curve 202 represents a relation after remounting. Each curve is drawn by changing the voltage applied to the sample introduction pipe 108a from 0 V to +5000 V with a step width of 250 V and obtaining an amount of ions in each step.

It was observed that a detection sensitivity at the time of 5000 V applied was almost the same, while shapes in the vicinity of an optimum value in the curve 201 before the mounting were different before and after the remounting of the sample introduction pipe. At this time, it was confirmed that there was almost no change even when a mounting situation was visually confirmed. In addition, a relation between the detection sensitivity and the voltage applied to the sample introduction pipe in a case where the same work was performed several times was different as in the curve 201 or the curve 202. Based on this result, it is considered that the ionization efficiency changes depending on a use situation, maintenance work, and the like of the sample introduction pipe by a user.

In addition, the electrodes and quadrupole mass filters inside the vacuum chamber have three-dimensional arrangements by assembly and individual differences of parts themselves, respectively. It is considered that due to the individual differences, the spatial distribution in which ions are accumulated inside the vacuum chamber may be different. In this case, it is considered that an electric field is formed by the accumulated ions, and the electric field serves as a barrier to change the ion permeability.

### Experiment 2

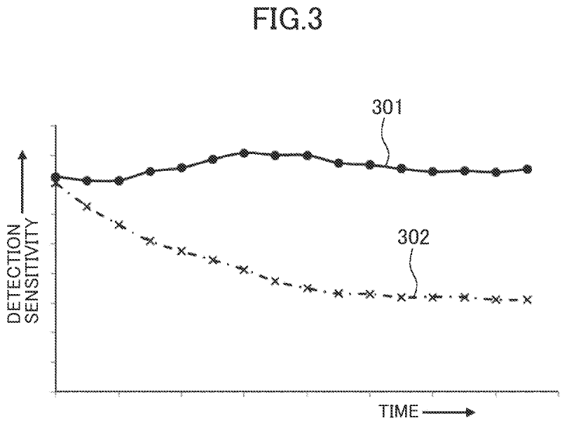

FIG. 3 illustrates a change in a detection sensitivity when the same sample is measured for a fixed time period. Each curve is drawn by obtaining an amount of ions for 15 seconds in one-second-steps. A curve 302 was obtained by fixing electrode voltages for 15 seconds, while a curve 301 was obtained by setting a time to switch a polarity between positive and negative in one location of the quadrupole mass filter 112b for the fixed time period between the one-second-steps.

In the curve 302, the detection sensitivity deteriorates over time, whereas in the curve 301, the detection sensitivity is kept constant. In addition, as in the case where the curve 301 was obtained, when a change in a detection sensitivity over time was measured by providing switching between positive and negative for the fixed time period for other electrodes and quadrupole mass filters, the detection sensitivity tended to deteriorate over time as in the case of the curve 302. Based on this result, it is considered that when the measurement is started, ions are gradually accumulated in the vicinity of the quadrupole mass filter 111b, the electric field serving as a barrier against the ions is formed, and the permeability is changed.

In addition, the dirt may accumulate on the electrodes and the quadrupole mass filters due to contact of the introduced ions or erroneous introduction of droplets or the like that have not been vaporized in an ion introducer. Due to the dirt, it is considered that even when the same voltage as that when there is no dirt on the electrodes or the quadrupole mass filters is applied, the formed electric field is different and the permeability is changed.

Based on the above reason, it is understood that the ionization efficiency of the ion introducer 108 and the ion permeability in the vacuum chamber 109 change, and as a result, the detection sensitivity may change.

The detection sensitivity may change due to overlapping of composite factors, and it is very difficult for the user to specify and improve a cause of the change in the detection sensitivity of the mass spectrometer, and it takes time and is work with many mistakes. In the invention, by adding a device self-diagnosis mode that performs a series of procedures in accordance with a flowchart, this work becomes simple, quick, and easy for the user to understand.

### <Overall>

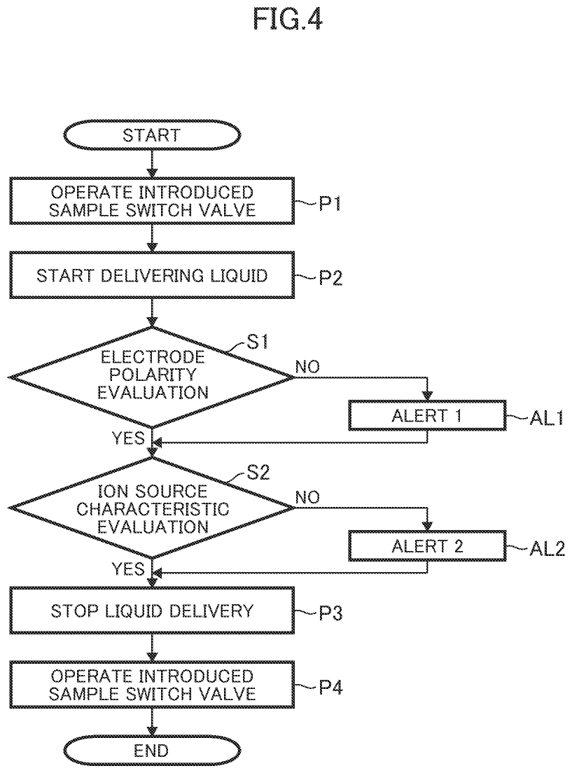

FIG. 4 illustrates a flowchart performed in the device self-diagnosis mode. Step P1: During normal measurement, the user performs measurement using an external pump (not shown) connected to the introduced sample switch valve 107c. The external pump (not shown) is, for example, a high-performance liquid chromatograph connected to a column or a syringe pump. A flow path (flow path for analysis) from the external pump is connected to the ion introducer 108 via the introduced sample switch valve 107c. The user prepares the calibration sample solution 107a before starting the measurement, and connects the calibration sample solution 107a to a flow path for calibration to which the liquid delivery pump 107b is connected. Thereafter, the user issues an instruction to shift to the device self-diagnosis mode through the main controller 105. In response to the instruction, the introduced sample switch valve 107c operates to switch from the flow path for analysis to the flow path for calibration connected to the liquid delivery pump 107b.

Step P2: The liquid delivery pump 107b starts to operate, and the delivery of the placed calibration sample solution 107a starts under conditions specified in advance by the analysis controller 104. After a previously specified waiting time required to stabilize the delivery, the procedure proceeds to step S1.

Step S1: An electrode polarity evaluation is performed as an evaluation for confirming that ions are not accumulated in the vacuum chamber 109. A sample in the calibration sample solution 107a is ionized by the ion introducer 108 constituting the ion source, and ions accumulated in the electrodes 111a to 111d and the quadrupole mass filters 112a to 112d constituting the mass spectrometry unit are detected based on a change in the ion permeability over time. Based on the electrode polarity evaluation, when the ions are accumulated and a loss amount of the ions exceeds a specified threshold, an alert 1 (AL1) is displayed on the display unit 106.

Step S2: An ion source characteristic evaluation is performed in order to confirm the ionization efficiency. A change in the ionization efficiency of the ion introducer 108 constituting the ion source is detected based on a change in an amount of ions with respect to a gas flow rate for the ion source or a voltage of the ion source introduced by the gas introduction pipe 108b. When the ionization efficiency falls below the specified threshold or an ionization characteristic is different from the previously stored characteristic, an alert 2 (AL2) is displayed on the display unit 106.

Step P3: The liquid delivery pump 107b is stopped operating.

Step P4: The introduced sample switch valve 107c operates to switch to an original flow path of the external pump (not shown).

After the device self-diagnosis mode ends, the main controller 105 causes the display unit 106 to display that the device self-diagnosis mode ends.

By these series of steps, the user uses the device self-diagnosis mode and confirms the alert 1 and the alert 2, thereby confirming whether an abnormality is present in each of the ionization efficiency of the ion introducer 108 and the ion permeability in the vacuum chamber 109.

Incidentally, since the ion permeability may be affected by a mass-to-charge ratio of ions, a sample having various mass-to-charge ratios is preferably used as the calibration sample solution 107a. An example thereof includes a sample used for mass axis adjustment of the mass spectrometer.

Data and an analysis value (data analyzed by the data analyzer 103b) obtained in steps S1 and S2 are stored in the data storage unit 103a. By using the stored data, it is also possible to display, on the display unit 106, a plot from which a change of a device state over time can be confirmed, and the user can determine an execution timing of the maintenance work.

Since an order of steps S1 and S2 may not affect the measurement, the order may be freely replaced. In addition, since only any one of measurement in steps S1 and S2 is performed due to diagnosis of different portions of the device, it is possible to further shorten a measurement time. However, in this case, the user cannot obtain comprehensive information for an abnormal portion of the device.

Next, flowcharts of measurement performed in the electrode polarity evaluation and the ion source characteristic evaluation will be described.

### <Electrode Polarity Evaluation>

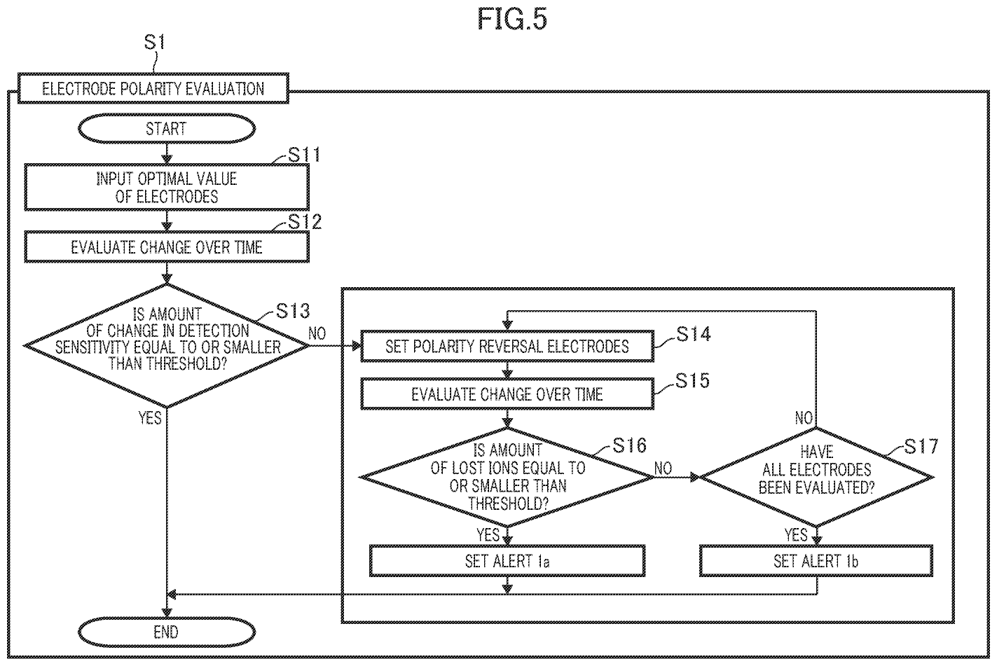

FIG. 5 shows a flowchart of measurement performed in the electrode polarity evaluation. Step S11: An optimum value for the calibration sample solution 107a is stored in the electrode polarity evaluation controller 104a in advance for the electrodes 111a to 111d and the quadrupole mass filters 112a to 112d. The optimum value for the calibration sample solution 107a is a voltage value at which an amount of ions is maximized with respect to a loaded sample. A recorded optimal voltage is input via the analysis controller 104 to change an applied voltage.

Step S12: A measurement method for the electrode polarity evaluation is stored in advance in the electrode polarity evaluation controller 104a, the measurement is started in accordance with the measurement method, and a change in an ion detection sensitivity over time is measured. The ion detection sensitivity is measured for a predetermined time period in a state in which the optimal voltage is applied to the electrodes 111a to 111d and the quadrupole mass filters 112a to 112d. Two detection sensitivities, that is, a previously specified detection sensitivity at several seconds immediately after the start of measurement and a detection sensitivity after a fixed time period, are measured. Then, the change in the ion detection sensitivity over time is obtained by comparing an ion detection sensitivity at a time point immediately after the start of the measurement with the ion detection sensitivity when the predetermined time period elapses. A change amount in the detection sensitivity is calculated based on a ratio of the two measured values by Equation (2).

(Change amount in detection sensitivity)=(Detection sensitivity after fixed time period from start of measurement)/(Detection sensitivity at several seconds immediately after start of measurement)−1 (2)

Step S13: The change amount in the detection sensitivity is compared with the specified threshold. One of the electrodes 111a to 111d and one of the quadrupole mass filters 112a to 112d to be determined are specified one by one. Then, it is determined whether the change in the ion detection sensitivity over time is normal or abnormal by comparing the change amount in the change in the ion detection sensitivity over time with a specified predetermined threshold. When the change amount in the detection sensitivity is within the specified threshold range, the electrode polarity evaluation ends. When the change amount is outside the threshold range, it is determined that the change in the ion detection sensitivity over time is abnormal, and the procedure proceeds to step S14.

Step S14: The electrodes 111a to 111d and the quadrupole mass filters 112a to 112d are sequentially specified as polarity reversal electrodes. In order to eliminate ions accumulated in the vicinity of the quadrupole mass filters, the electrode polarity evaluation controller 104a performs control so as to set a time to switch a polarity between positive and negative for a fixed time period in the specified electrodes.

Step S15: The change in the detection sensitivity over time is measured under conditions specified in step S14. After a voltage of a reverse potential to the optimal voltage is applied to the specified polarity reversal electrode for a fixed time period, the ion detection sensitivity is measured for a predetermined time period while the optimal voltage is applied. As in step S12, two detection sensitivities, that is, the previously specified detection sensitivity at several seconds immediately after the start of the measurement and the detection sensitivity after a fixed time period, are measured. The loss amount of the ions is calculated based on the ratio of the two measured values by Equation (2). The loss amount of the ions corresponds to the change amount in the detection sensitivity when the ionization efficiency of the ion introducer 108 is assumed to be constant in Equation (1), that is, the ion permeability in the vacuum chamber 109.

Step S16: The loss amount of the ions is compared with the specified threshold. It is determined whether the change in the ion detection sensitivity over time corresponding to the loss amount of the ions is normal or abnormal by comparing the change amount in the change in the ion detection sensitivity over time corresponding to the loss amount of the ions with the specified predetermined threshold. When the loss amount of the ions is within the specified threshold range, it is determined that an abnormality is present in the polarity reversal electrodes, an alert 1a is displayed on the display unit 106, and the electrode polarity evaluation ends. When the loss amount of the ions is outside the threshold range, the procedure proceeds to step S17.

Step S17: It is confirmed whether all the electrodes, that is, the electrodes 111a to 111d and the quadrupole mass filters 112a to 112d are specified as the polarity reversal electrodes and evaluated. When all the electrodes are evaluated, an alert 1b is displayed on the display unit 106, and the electrode polarity evaluation ends. When all the electrodes are not evaluated, the procedure proceeds to step S14 again, and the next electrode is selected and evaluated. Step S14 and subsequent steps are executed to determine whether any of the electrodes 111a to 111d and the quadrupole mass filters 112a to 112d are dirty. After all the electrodes are specified as the polarity reversal electrodes and the polarity is switched between positive and negative, when the specified polarity reversal electrodes are no longer determined to be abnormal, it can be determined that ions are accumulated on the polarity reversal electrodes.

The alert 1a indicates that charges are accumulated on the electrodes 111a to 111d and electrodes of the quadrupole mass filters 112a to 112d, and the user can confirm whether the charges are easily accumulated on any of the electrodes 111a to 111d and the quadrupole mass filters 112a to 112d. In addition, when the alert 1a is issued, the user can take measures to avoid accumulation of the ions and prevent deterioration of the detection sensitivity by interposing electrode polarity reversal during the analysis.

It is understood that the alert 1b indicates that the charges are not accumulated in the electrodes 111a to 111d and the electrodes of the quadrupole mass filters 112a to 112d, but the detection sensitivity is varied due to other factors.

By periodically performing the electrode polarity evaluation, the user can know a degree of dirt in the electrodes 111a to 111d and the quadrupole mass filters 112a to 112d without disassembling the device based on a change of a measurement result over time stored in the data storage unit 103a. Accordingly, the user can determine the execution timing of the maintenance work for cleaning the electrodes, and may shorten a downtime due to device stop or the like caused by an unexpected abnormality.

The evaluation of the change in the detection sensitivity performed in steps S12 and S13 may be performed by other methods. In a currently specified method, only two points immediately after the start and after the specified time are compared with each other, and a change in a detection sensitivity related to the other time is not analyzed. Therefore, when the detection sensitivity varies over time immediately after the start and at a measurement time other than the specified time, the determination is not made. Therefore, it is considered that when it is desired to analyze the change over time in more detail, for example, the change amount in the detection sensitivity is calculated by the same calculation as in Equation (2) at each measurement time to perform the threshold determination. By performing the determination, it is also possible to determine a state of the electrodes in more detail.

In the above-described example, in the analysis of variation of the detection sensitivity over time, it is not possible to determine the variation over time equal to or less than a measurement cycle of a measurement point. Therefore, in the previously stored measurement method for the electrode polarity evaluation, the measurement cycle is shortened, and variation over time in different cycles may be observed at the same time by executing smoothing in the data analysis unit 103. Therefore, it is also possible to prepare an analysis pattern within several patterns in the data analysis unit 103, analyze data in a single electrode polarity evaluation by each of the patterns prepared in step S12, and perform each threshold determination in step S13, thereby distinguishing factors of the change in the detection sensitivity of the several patterns and giving additional information to the user.

### <Ion Source Characteristic Evaluation>

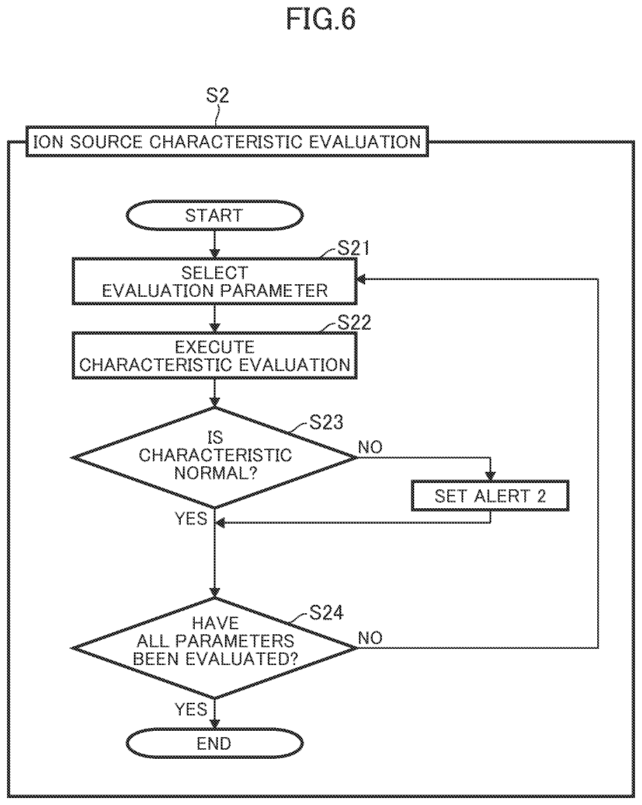

FIG. 6 illustrates a flowchart of measurement performed in the ion source characteristic evaluation. Step S21: The ion source characteristic evaluation controller 104b stores a group of parameters adjustable by the ion introducer 108 for a sample. The group of parameters includes a plurality of pairs of control values for a gas flow rate to be applied for the ion source and control values for a voltage to be applied to the ion source, and a normal value of a detection sensitivity of ions in the sample for the plurality of pairs. The parameters include, for example, spray gas forming spray, auxiliary gas forming high-temperature gas, a voltage applied to the ion introducer 108, and the like. The ion source characteristic evaluation controller 104b sequentially selects a parameter as a characteristic evaluation parameter from the group of parameters.

Step S22: A list of control values of parameters and a measurement method are stored in the ion source characteristic evaluation controller 104b for the specified parameters, and the measurement is performed based on the list of control values and the measurement method. The control values for the plurality of pairs in the group of parameters are sequentially applied, and the detection sensitivity of ions in the sample for each of the pairs is measured to measure a characteristic of the ion source for the gas flow rate and the voltage. After the measurement, the measured detection sensitivity is normalized by a detection sensitivity of one point in the list of control values. One point used as a standard for the normalization is, for example, a point at which the gas flow rate is maximum among the control values for the gas, and a point at which the voltage is maximum for the applied voltage.

Step S23: The ion source characteristic evaluation controller 104b stores parameter dependence of a detection sensitivity of a calibration sample in a normal state for the specified parameter. In addition, the ion source characteristic evaluation controller 104b also stores an optimum value for the specified parameter. The data analysis unit 103 compares the deterioration of the ionization efficiency according to the following Equation (3). The measured ion detection sensitivity for the gas flow rate and the voltage is compared with the previously stored normal value of the ion detection sensitivity according to Equation (3), and when the deterioration of the ionization efficiency exceeds a specified threshold, the alert 2 indicating that the specified parameter is abnormal is issued.

(Deterioration in ionization efficiency)=(measured detection sensitivity at optimum value)/(stored detection sensitivity at optimum value at normal time)−1 (3)

Step S24: It is confirmed whether all the parameters of the ion introducer 108 are specified as evaluation parameters and evaluated. When all the parameters are evaluated, the ion source characteristic evaluation ends. When all the parameters are not evaluated, the procedure proceeds to step S21 again, and the next parameter is selected and evaluated.

The alert 2 indicates a possibility that the ion introducer 108 is not correctly mounted or dirt is accumulated. When it is determined that the specified parameter is abnormal, it can be determined that the ion introducer 108 constituting the ion source is abnormal. The user can determine an execution timing of maintenance work of the ion introducer 108 by confirming the alert.

In addition, by performing the ion source characteristic evaluation immediately after the maintenance work of the ion introducer 108, the user can determine whether the maintenance work of the ion introducer 108 is correctly performed. Accordingly, it is possible to prevent deterioration of the detection sensitivity due to the maintenance work itself.

Further, by periodically performing the ion source characteristic evaluation, the user can determine a state of the ion introducer 108 without disassembling the device based on the change of the measurement result over time stored in the data storage unit 103a. Accordingly, the user can determine the execution timing of the maintenance work of the ion introducer 108, and may shorten a downtime due to the device stop or the like caused by the unexpected abnormality.

Deterioration evaluation of the ionization efficiency performed in step S23 may be performed by other methods. In a currently specified method, only two points, that is, the optimum value and a specified reference value are compared with each other, and the change in the ionization efficiency at the other control values is not analyzed. Therefore, it is considered that when it is desired to analyze the change in the ionization efficiency in more detail, for example, the change amount in the ionization efficiency is calculated by the same calculation as in Equation (3) with each control value to perform the threshold determination. By performing the determination, it is also possible to determine a state of the deterioration of the ionization efficiency in more detail.

As described above, the invention provides a mass spectrometer including a self-diagnosable hardware configuration (a liquid delivery function by a pump and a sample loading location), having (A) a function of detecting the deterioration of the ionization efficiency based on gas dependence and voltage dependence, and (B) a function of detecting the deterioration of the ion permeability, that is, reduction of permeability of an electrode portion inside a vacuum chamber, based on polarity dependence of electrodes and quadrupole filters, and configured to, when measurement values detected in (A) and (B) exceed a fixed threshold, generate a specific alarm based on information specified in (A) and (B). Accordingly, by using the device self-diagnosis mode, the user can easily and clearly understand a state of the device, and can determine the execution timing of maintenance. In addition, it is possible to provide a mass spectrometer that has the device self-diagnosis mode having a plurality of step, in which different abnormal locations can be found in the respective steps, and a user may perform predetermined maintenance work by a report thereof.

Incidentally, the invention is not limited to the above embodiment, and includes various modifications. For example, the above embodiments have been described in detail for easy understanding of the invention, and the invention is not necessarily limited to those including all of the configurations described above. In addition, a part of configurations of one embodiment can be replaced with configurations of another embodiment, and configurations of one embodiment can be added to configurations of another embodiment. Further, another configuration may be added to a part of the configurations of each embodiment, and the part of the configuration may be deleted from or replaced with the other configuration.

### REFERENCE SIGNS LIST

101: measurer
102: analog-to-digital converter
103: data analysis unit
103a: data storage unit
103b: data analyzer
103c: error determiner
104: analysis controller
104a: electrode polarity evaluation controller
104b: ion source characteristic evaluation controller
105: main controller
106: display unit
107: sample introducer
107a: calibration sample solution
107b: liquid delivery pump
107c: introduced sample switch valve
108: ion introducer
108a: sample introduction pipe
108b: gas introduction pipe
109: vacuum chamber
110: pipe
111a to 111d: electrode
112a to 112d: quadrupole mass filter
113: ion detector

1. A method for controlling a mass spectrometer including
an ion source that ionizes a compound in a sample,
a mass spectrometry unit that separates ions based on a mass-to-charge ratio, and
a plurality of electrodes that form an electric field that transports ions generated by the ion source to the mass spectrometry unit, the method comprising:
ionizing the sample by the ion source;
detecting, based on a change in ion permeability over time, ions accumulated in the electrodes and quadrupole mass filters forming the mass spectrometry unit; and
detecting a change in ionization efficiency of the ion source based on a change in an amount of ions with respect to a gas flow rate for the ion source or a voltage of the ion source.

2. The method according to claim 1, further comprising:
measuring, for a predetermined time period, an ion detection sensitivity in a state in which an optimal voltage that maximizes an amount of ions in the sample is applied to the electrodes and the quadrupole mass filters;
calculating a change in the ion detection sensitivity over time by comparing the ion detection sensitivity at a time point immediately after the start of the measurement with the ion detection sensitivity when the predetermined time period elapses;
comparing the change in the ion detection sensitivity over time with a predetermined threshold to determine whether the change in the ion detection sensitivity over time is normal or abnormal; and
determining whether any of the electrodes and the quadrupole mass filters is dirty when it is determined that the change in the ion detection sensitivity over time is abnormal.

3. The method according to claim 2, further comprising:
specifying one of the electrodes and one of the quadrupole mass filters in such a manner that the specified electrode and the specified quadrupole mass filter are to be subjected to determination of whether a change in the ion detection sensitivity over time is normal or abnormal;
sequentially specifying one of the electrodes and one of the quadrupole mass filters as polarity reversal electrodes;
measuring, after a voltage that is at a reverse potential of the optimal voltage is applied to the specified polarity reversal electrodes for a fixed time period, the ion detection sensitivity for the predetermined time period while applying the optimal voltage;
obtaining a change in the ion detection sensitivity over time by comparing the ion detection sensitivity at a time point immediately after the start of the measurement with the ion detection sensitivity when the predetermined time period elapses;
comparing the change in the ion detection sensitivity over time with a predetermined threshold to determine whether the change in the ion detection sensitivity over time is normal or abnormal; and
determining that ions are accumulated in the polarity reversal electrodes, when it is not determined that a change in the ion detection sensitivity over time is abnormal in the specified polarity reversal electrodes.

4. The method according to claim 1, further comprising:
storing, for the sample, a plurality of pairs of control values for the gas flow rate to be applied for the ion source and control values for the voltage to be applied to the ion source, and a normal value of the detection sensitivity of ions in the sample for the plurality of pairs; and
sequentially applying the control values for the plurality of pairs and measuring the detection sensitivity of ions in the sample for each of the pairs to measure a characteristic of the ion source for the gas flow rate and the voltage.

5. The method according to claim 4, further comprising:
comparing the measured ion detection sensitivity for the gas flow rate and the voltage with the previously stored normal value of the ion detection sensitivity; and
determining that an abnormality is present in the ion source when it is determined that the measured ion detection sensitivity is abnormal.
